(19) United States
(12) Patent Application Publication
(10) Pub. No.: US 2013/0038485 A1
(43) Pub. Date: Feb. 14, 2013

(54) DATA ANALYSIS METHOD AND APPARATUS FOR ESTIMATING TIME-AXIS POSITIONS OF PEAK VALUES WITHIN A SIGNAL BASED ON A SERIES OF SAMPLE VALUES OF THE SIGNAL

(71) Applicant: Mitsuo NAKAMURA, Nagoya (JP)

(72) Inventor: Mitsuo NAKAMURA, Nagoya (JP)

(73) Assignee: DENSO CORPORATION, Kariya-city (JP)

(21) Appl. No.: 13/537,735

(22) Filed: Jun. 29, 2012

(30) Foreign Application Priority Data
Aug. 10, 2011 (JP) 2011-175027

(51) Int. Cl. G01S 13/08

(52) U.S. Cl. 342/118; 342/195

(57) ABSTRACT

A series of samples derived by fixed-frequency sampling of a received signal are processed to detect (local) maximum-value and minimum-value samples. For each of the maximum-value samples, a corresponding reference value and a corresponding group of samples are derived. The reference value is set higher than that of a minimum-value sample which adjoins the maximum-value sample, and the corresponding group consists of successively adjacent samples including the maximum-value sample, each having a higher value than the reference value. The estimated time-axis position of a peak value of the received signal is obtained within the range of time-axis positions of the corresponding group.

### CROSS-REFERENCE TO RELATED APPLICATIONS

This application is based on and incorporates herein by reference Japanese Patent Application No. 2011-175027 filed on Aug. 10, 2011.

### BACKGROUND OF THE INVENTION

1. Field of Application

The present invention relates to a data analysis apparatus for estimating time-axis positions of peak values within a signal, based upon a series of samples of the signal, and to a data analysis method implemented by the apparatus. The invention further relates to a radar apparatus which incorporates such a data analysis apparatus.

2. Background Technology

Types of radar apparatus are known which apply data analysis to digital samples of a received signal, for detecting reflected waves received from target objects. Specifically, during an interval after a pulse of radar waves has been transmitted, a received signal expressing intensity values of resultant reflected waves is sampled, at a fixed sampling frequency. The data constituted by a time-series of sample values thus obtained is then analyzed, to estimate the time-axis positions of peak amplitude values of the received signal, thereby enabling distances of target objects to be estimated.

A method of performing such data analysis is described for example in Japanese patent application publication No. 2008-014722, referred to in the following as reference document 1. With such a method, groups of successively adjacent samples which are each above a predetermined base value are extracted from a series of samples of a received signal, such groups being referred to as “peak regions” in the following. The time-axis positions of one or more peak values of the sampled signal within each peak region are estimated. The method of reference document 1 will be summarized referring to FIGS. 10A˜10C.

In FIG. 10A, a peak region consists of a group of 13 samples, with the value of the highest of these samples indicated as the peak maximum value. A reference value can be calculated as the product of the peak maximum value and a fixed coefficient k, and two intersection timings T1 and T2 can be derived based on the amplitude relationship between that reference value and values of samples in a leading part and a trailing part, respectively, of the peak region, as shown. The position of a peak value of the sampled signal can then estimated as the mid-point between T1 and T2.

However if the peak region contains a plurality of maximum-value samples, i.e., includes at least one minimum-value sample as in FIG. 10A, accurate estimation is not achieved. In that case, with the method of reference document 1, the minimum-value sample is reduced to the base (zero) level, as shown in FIG. 10B. Two separate single-peak regions are thereby extracted, having respective maximum sample values indicated as peak 1 maximum value and peak 2 maximum value, as shown in FIG. 10C. Each of these peak regions is then operated on as described referring to FIG. 10A, to obtain two pairs of intersection timings T1-1, T2-1 and T1-2, T2-2. The estimated positions of two peak values of the received signal are then obtained as the respective mid-points of the pairs T1-1, T2-1 and T1-2, T2-2.

However with such a method, since the actual amplitude of the minimum-value sample is converted to zero, the intersection timings T2-1 and T1-2 are not accurate, with the degree of inaccuracy depending upon the sampling period. Hence with such a prior art method, it is not possible to estimate the time--axis positions of peaks of the received signal to a high degree of reliability, when a peak region contains a plurality of maximum-value samples.

This problem is not limited to a radar apparatus which employs such a method of estimating time-axis positions of peaks within a received signal, but applies in general to types of data analysis apparatus which utilize such a method.

### SUMMARY

Hence it is desired to overcome the above problem, by providing a data analysis apparatus which enables reliable estimation of time-axis positions of a plurality of peak values of an input signal, based on a series of samples of that signal, and by providing a data analysis method which is implemented by such an apparatus.

From a first aspect, the disclosure provides a data analysis apparatus which processes a series of samples of an input signal, obtained by sampling the input signal at a fixed sampling frequency, with the apparatus includes maximum/minimum value detection circuitry and peak position estimation circuitry. The maximum/minimum value detection circuitry applies data analysis to the series of samples for detecting maximum-value samples and minimum-value samples (i.e., having local maximum and local minimum values) within the series. The peak position estimation circuitry estimates the time-axis positions of peak values of the input signal based upon the detected maximum-value samples and minimum-value samples.

Specifically, the peak position estimation circuitry determines, for each of the maximum-value samples, a corresponding reference value and a corresponding group of samples. The corresponding reference value is made higher than that of a minimum-value sample which adjoins the maximum-value sample (where “adjoins” signifies that the minimum-value sample immediately precedes or succeeds the maximum-value sample, within an alternating sequence of maximum-value samples and minimum-value samples). The corresponding group consists of a plurality of successively adjacent samples which include the maximum-value sample have respective values higher than the corresponding reference value. The estimated time-axis position of a peak value of the input signal is obtained as a position within the range of time-axis positions of the corresponding group.

The maximum/minimum value detection circuitry may comprise comparator circuitry, status recording circuitry, time-series control circuitry, and extreme value detection circuitry. The comparator circuitry repetitively performs an operation of selecting one of the samples of the series as an object sample (i.e., with each of the samples being selected in turn), and comparing the object sample with the immediately preceding sample in the series. The status recording circuitry records a status value in accordance with the result of the comparison. The time-series control circuitry controls the comparator circuitry to select successive samples of the series as being the current object sample. When the status value becomes changed (i.e., there is a change to a condition in which the object sample is higher than the preceding sample, or to a condition in which the preceding sample is higher than the object sample), the extreme value detection circuitry detects the preceding sample as being either a maximum-value sample or a minimum-value sample, in accordance with that change.

More specifically, when the object sample is judged to be higher than the immediately preceding sample, this indicates a rising condition, while when the object sample is judged to be lower than the immediately preceding sample, this indicates a falling condition. When there is a change from the rising condition to the falling condition, the immediately preceding sample is detected as a maximum-value sample, while conversely, when there is a change from the falling condition to the rising condition, the immediately preceding sample is detected as a minimum-value sample.

This enables the maximum/minimum value detection circuitry to be simplified by comparison with the prior art, since detection is performed by comparing only two samples at a time, as opposed to the prior art whereby sets of three or more consecutive samples must be successively processed for detecting maximum-value samples and minimum-value samples within a series of samples.

Such a data analysis apparatus may be advantageously applied to a radar apparatus which transmits radar waves and receives resultant reflected waves from target objects, to derive a received signal varying in amplitude in accordance with intensity of the received waves, and which includes an analog/digital converter circuit for converting the received signal to a series of samples by sampling at a fixed frequency. In such an application, the data analysis apparatus processes the series of samples, for estimating time-axis positions of peak values of the received signal. Respective distances of the target objects can then be estimated, based on the estimated time-axis positions of the peak values.

In particular when applied to such a radar apparatus, the maximum minimum value detection circuitry may be configured to extract a plurality of peak regions from the series of samples, with each of the peak regions comprising a plurality of successively adjacent samples having values higher than a predetermined base value. In that case, each of the peak regions is processed to detect maximum-value samples and minimum-value samples therein.

The peak position estimation circuitry is preferably configured to derive a pair of time-axis positions referred to as the first and second intersection timings, with respect to each maximum-value sample for which a reference value is derived. The first intersection timing is derived based on comparing the reference value with samples which precede the maximum-value sample and, which include samples of the group corresponding to that maximum-value sample. The second intersection timing is derived based on comparing the reference value with samples which succeed the maximum-value sample and which include samples of the corresponding group. The time-axis position of a peak value of the sampled signal is then obtained as a point midway between the first and second intersection timings,

Alternatively, the peak position estimation circuitry may be is configured to calculate (with respect to each maximum-value sample) a two-dimensional enclosed region, in a graph of amplitude values versus time values. The region is enclosed between the samples of the corresponding group (i.e., with the samples expressed as points in the graph) and the corresponding reference value, with each pair of adjacent samples of the group being connected by line segments (i.e., successions of amplitude/time points calculated assuming a linear relationship between amplitude and time). The time-axis position of a peak value of the input signal is obtained as that of the centroid of the enclosed region.

The peak position estimation circuitry is preferably configured such that, when a maximum-value sample is preceded by a first adjoining minimum-value sample and is succeeded by a second adjoining minimum-value sample, the corresponding reference value of the maximum-value sample is made higher than the higher one of these adjoining minimum-value samples.

With the present invention, when such a reference value is derived based on an adjoining minimum-value sample, the value of that sample is left unchanged. Hence, greater accuracy and reliability of detecting peak values can be achieved, by comparison with prior art methods whereby the value of such an adjoining minimum-value sample is distorted, as described hereinabove referring to FIGS. 10A˜10C.

From another aspect, the disclosure provides a method of data analysis for estimating respective time-axis positions of peak values of an input signal by processing a series of samples of the input signal, the series being obtained by sampling the input signal at a fixed sampling frequency.

The method comprises a step of operating on the series of samples in succession, to detect maximum-value samples and minimum-value samples within the series, and a step of estimating the time-axis positions of the peak values of the input signal, based upon the detected maximum-value samples and minimum-value samples.

The step of estimating time-axis positions of the peak values consists of determining, with respect to each of the maximum-value samples, a corresponding reference value and a corresponding group of samples. The corresponding reference value is made higher than a minimum-value sample which adjoins the maximum-value sample. The corresponding group of samples comprises a plurality of successively adjacent samples which include the maximum-value sample and which are each above the corresponding reference value. The time-axis position of a peak value of the input signal is obtained as a position within the range of time-axis positions of that corresponding group of samples.

When a maximum-value sample is preceded by a first adjoining minimum-value sample and is succeeded by a second adjoining minimum-value sample, the reference value corresponding to the maximum-value sample is preferably made higher than a higher one of the first minimum-value sample and the second minimum-value sample.

The step of analyzing the series of samples to detect positions of maximum-value samples and minimum-value samples preferably comprises a repetitively performed series of operations whereby each sample of the series is selected in turn as an object sample, with the respective values of the currently selected object sample and the immediately preceding sample being compared. If the object sample is judged to be higher in value than the immediately preceding sample, a status value is recorded as indicating a falling condition (i.e., indicating that samples of the series are successively decreasing in amplitude), while if the object sample is lower in value than the immediately preceding sample, the status value is recorded as indicating a rising condition. Each time the status value changes from indicating the rising condition to indicating the falling condition, the immediately preceding sample is detected as being a maximum-value sample, while when the status value changes from indicating the falling condition to indicating the rising condition, the immediately preceding sample is detected as being a minimum-value sample.

The step of detecting time-axis positions of the maximum-value samples and minimum-value samples may be implemented by circuitry controlled to operate as a state machine, which executes a sequence of data processing operations in accordance with successively entered states.

### BRIEF DESCRIPTION OF THE DRAWINGS

FIG. 1 is a system block diagram showing the general configuration of an embodiment of a radar apparatus;

FIGS. 2A to 2E are timing diagrams for use in describing the operation of the radar apparatus embodiment;

FIG. 3 is a basic flow diagram of data analysis processing executed by the radar apparatus for detecting distances of target objects;

FIG. 4 is a graph illustrating a series of signal samples arrayed at successive time-axis positions;

FIGS. 5 and 6 constitute a state transition diagram illustrating logic operations executed by the embodiments for detecting maximum-value samples and minimum-value samples within a series of received signal samples;

FIG. 7A shows an example of an extracted peak region, containing a single peak value of the sampled signals, while FIG. 7E shows an example of an extracted peak region which contains a pair of peak values of the sampled signal;

FIGS. 8A and 8B show respective examples of extracted peak regions which contain three peak values of the sampled signal;

FIGS. 8C and 8D illustrate a method of determining peak threshold values for use in estimating positions of peak values of a sampled signal within a series of samples of the signal;

FIGS. 9A, 9B are diagrams for describing processing to estimate the position of a peak value of a sampled signal as a position of a centroid of an enclosed region;

FIGS. 10A˜10C are diagrams for describing a prior art method of estimating respective positions of peak. values of a sampled signal within a series of samples of the signal; and

FIG. 11 is a flow diagram of processing executed for calculating peak threshold values for respective peak regions with the above embodiment.

### DESCRIPTION OF PREFERRED EMBODIMENTS

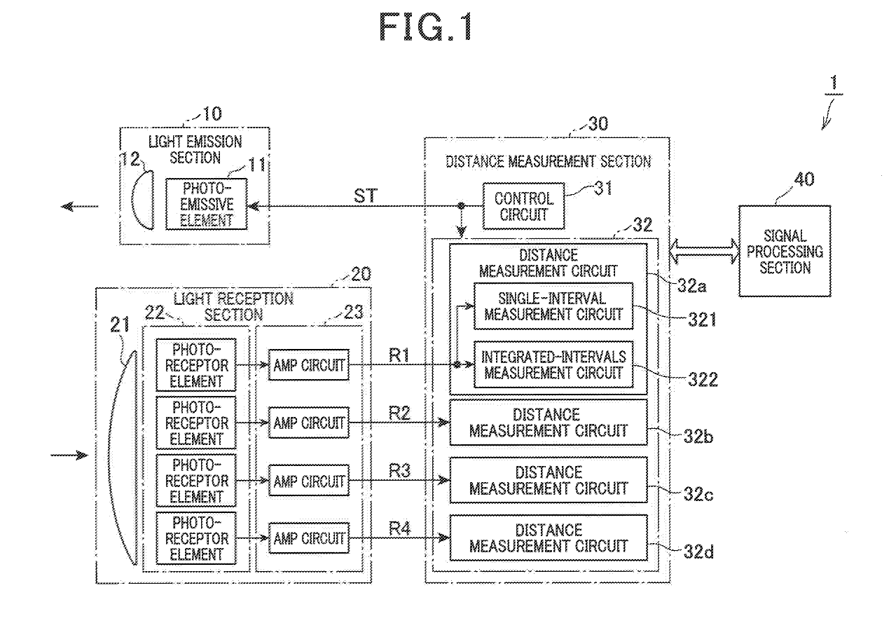

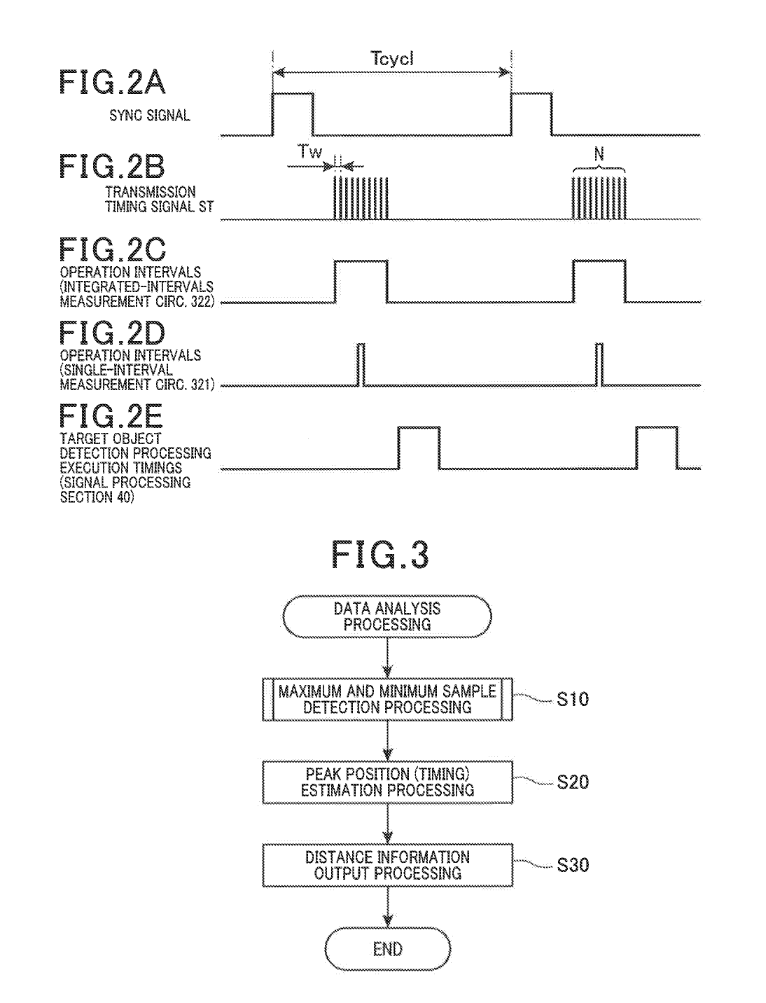

FIG. 1 is a block system diagram showing the overall configuration of an embodiment of a radar apparatus 1, for installation in a host vehicle. FIGS. 2A˜2E are timing diagrams for use in describing the operation of the radar apparatus 1. As shown in FIG. 1, the radar apparatus 1 includes a light emission section 10, a light receiving section 20, a distance measurement section 30 and a signal processing section 40. The light emission section 10 emits pulses of laser light in accordance with a timing signal ST shown in FIG. 2B, with the laser light being directed into to a region ahead of the host vehicle (referred to in the following as the illuminated region). Resultant reflected laser light waves, due to reflections from one or more target objects in the illuminated region, are received by the light receiving section. 20 during an interval Tw immediately following each transmission of a laser light pulse. Received signals R1 to R4 are thereby derived by the light receiving section 20 in accordance with intensity values of the received reflected waves, and are supplied to the distance measurement section 30. The distance measurement section 30 generates the transmission timing signal. ST, and analyzes the received signals R1˜R4 to obtain distance information (i.e., values of distance from which transmitted radar waves have been reflected), which is supplied to the signal processing section 40. Based on this distance information, the signal processing section 40 detects any target. objects within the illumination region, i.e., detects values of distance, velocity, etc., of such objects.

The light emission section 10 includes a laser diode 11 which generates laser light pulses in accordance with the transmission timing signal ST, and a collimator lens 12 for focusing the light emitted by the photo-emissive element 11 into the illumination region.

The light receiving section 20 includes a condensor lens 21 for focusing incident reflected light waves, and a set of photo-receptor elements 22 (with this embodiment, four photo-receptor elements 22) each producing an electrical signal at a voltage determined by the intensity of reflected light waves received via the condensor lens 21. A set of four amplifier circuits 23 receive the respective signals produced by the photo-receptor elements 22, and amplify these to obtain the received signals R1˜R2.

The photo-receptor elements 22 are arrayed to receive reflected light waves arriving along a plurality of respectively different directions from the illuminated region, these directions being within a common horizontal plane, parallel to the width direction of the host vehicle.

Each photo-receptor element 22 and the corresponding amplifier circuit 23 constitutes a channel which supplies a received signal, i.e., channels CHi (i=1˜4) supply the received signals Ri. The number of channels is not necessarily limited to four, and it would be equally possible to use a larger number of channels or a single channel.

The distance measurement section 30 includes a control circuit 31 and a set of measurement circuits 32a˜32d, which receive the respective received signals R1˜R4. Since each of the measurement circuits 32a˜32d are of identical configuration, these are referred to collectively as a measurement circuit 32 in the following. Each measurement circuit 32 can derive distance values by either of two different measurement methods, executed by a single-interval measurement circuit 321 and a integrated-interval measurement circuit 322 respectively as described in the following, based on the timing signal ST and the corresponding received, signal Ri. Unless otherwise specified, use of the single-interval measurement circuit 321 of each distance measurement circuit 32 is assumed in the following, with the received signal (one of the signals R1˜R4) which is inputted to the distance measurement circuit 32 being designated as Ri

Referring to FIGS. 2A˜2E, the timing signal ST is generated in synchronism with a synchronizing signal as periodic bursts (period Tcycl=33 ms for this embodiment) of N successive pulses (N=100 for this embodiment). The period Tw between successive pulses, shown in FIG. 2B, is made sufficiently long (Tw=18 μs for this embodiment) for laser light to travel to/from an object located at the maximum detection range of the radar apparatus 1 (with this embodiment, 50 m). However other values for Tcycl, N and Tw could equally be used, so long as the relationship Tcycl>N×Tw is satisfied.

Referring again to FIG. 1, during each interval in which N successive laser light pulses are emitted, each distance measurement circuit 32 performs data analysis of the corresponding received signal Ri during the operation interval (Tw) following an arbitrarily determined one of the N transmitted radar wave pulses (e.g., following the 50^{th} pulse, synchronized with the timing signal ST). Time-axis positions of peak values in each received signal are thereby estimated, and converted to corresponding distance values which are supplied to the signal processing section 40. If selected for use, the integrated-interval measurement circuit 322 of each distance measurement circuit 32 performs similar analysis, following each of the N pulses in succession, and integrates the results obtained. In other respects, the operation of a single-interval measurement circuit 321 is identical to that of an integrated-interval measurement circuit 322. With this embodiment, the single-interval measurement circuit 321 or the integrated-interval measurement circuit 322 of each distance measurement circuit 32 can be arbitrarily selected for use.

Each distance measurement circuit 32 performs A/D (analog-to-digital) conversion of the corresponding received signal Ri using a fixed sampling period (with this embodiment 12.5 ns), and analyzes the resultant series of sample values to obtain the required distance information.

The functions of each distance measurement circuit 32 of this embodiment (logic operations, temporary registering of values, storage of values in memory) are implemented by dedicated hardware circuitry such as a FPGA (Field-Programmable Gate Array) or ASIC (Application-Specific Integrated Circuit) in conjunction with an A/D converter circuit. This hardware implementation enables data analysis processing to be executed at higher speed than is attainable by software implementation (i.e., control program executed by a microcomputer). However in principle it would be possible to implement each distance measurement circuit 32 by software, or partially by hardware circuitry and partially by software.

The signal processing section 40 is a usual type of microcomputer based on a CPU, ROM and RAM, and performs processing based on the distance data supplied via channels CHi of the distance measurement section 30, for detecting distances, velocities, shapes, sizes, etc., of target objects.

### Processing Executed by Distance Measurement Circuit 32

The data analysis processing executed by a distance measurement circuit 32 will be described referring first to the basic flow diagram of FIG. 3. Once in each Tcycl period (FIGS. 2A˜2E) after a specific one of the N laser light beam pulses has been transmitted (e.g., the 50^{th} pulse), A/D conversion is applied with a fixed sampling period to the received signal Ri during a subsequent operation interval (Tw), to obtain a fixed number of samples. These samples are processed as shown in FIG. 3, to derive distance information.

Firstly in step S10 the samples are sequentially processed in order of their input numbers (i.e., assigned serial numbers which express respective time-axis positions following a transmitted light beam pulse). Successive groups of samples, referred to herein as peak regions, are extracted from the series of samples. Each peak region consists of a group of successively adjacent samples having amplitude values above a predetermined base value (with this embodiment, above the upper level of the noise range of the received signal Ri), and the samples of each peak region are stored in memory. Each peak region is subjected to data analysis processing for detecting maximum-value and minimum-value value samples (i.e., samples having local maximum and local minimum values of amplitude), and information specifying the maximum-value samples and minimum-value samples is also stored in memory, for use in the processing of step S20.

In step S20, peak position estimation processing is applied to each peak region for estimating respective (time-axis) positions of one or more peaks of the received signal Ri, based on the detected maximum-value and minimum-value samples within that peak region.

The positions of these peak values are then converted to respective distance values in step S30, and the distance information is outputted to the signal processing section 40.

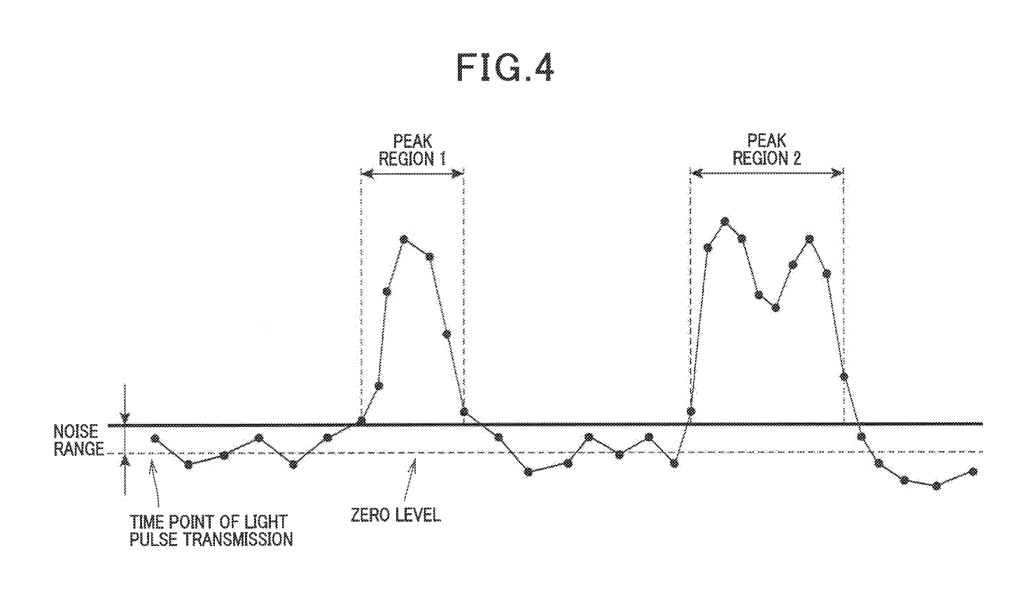

FIG. 4 illustrates the extraction of peak regions from the series of samples generated by A/D conversion of a received signal Ri following transmission of a laser light beam pulse. In FIG. 4, samples are indicated as respective points in a graph, with amplitude (i.e., corresponding to received light intensity) plotted along the vertical axis and time (input numbers) plotted along the horizontal axis. The input numbers are designated as ti (i=0, 1, 2, . . . n-1) in the following, with ti=0 corresponding to the time point of transmitting a laser light beam pulse, and corresponding amplitude values as ai. Thus the samples are expressed as

sample 1→(t1, a1)

sample 2→(t2, a2)

sample n→(tn, an)

Assuming for example that A/D conversion is performed at a sampling frequency of 80 MHz, the period between successive input numbers corresponds to 12.5 ns. Thus the time-axis position of a sample (with reference to the start of an operation interval) is (ti×12.5) ns. Strictly speaking, the actual position is obtained by adding the conversion delay time of the A/D conversion to (ti×12.5).

Each peak region contains one or more maximum-value samples, and hence one or more peak values of the received signal Ri, which may correspond to reflections from target objects.

In the example of FIG. 4, two peak regions (peak region 1 and peak region 2) are shown, with peak region 2 containing two maximum-value samples (hence, containing the positions of two peak values of the sampled signal) and peak region 1 containing a single maximum-value sample (hence, containing the position of a single peak value).

The noise range is obtained by multiplying the distributed absolute value of received signal noise by a constant, and may be determined based on experiment or by applying arbitrary values. It should be noted that it would be equally possible to use the (received signal) zero level as a base value for extracting the peak regions.

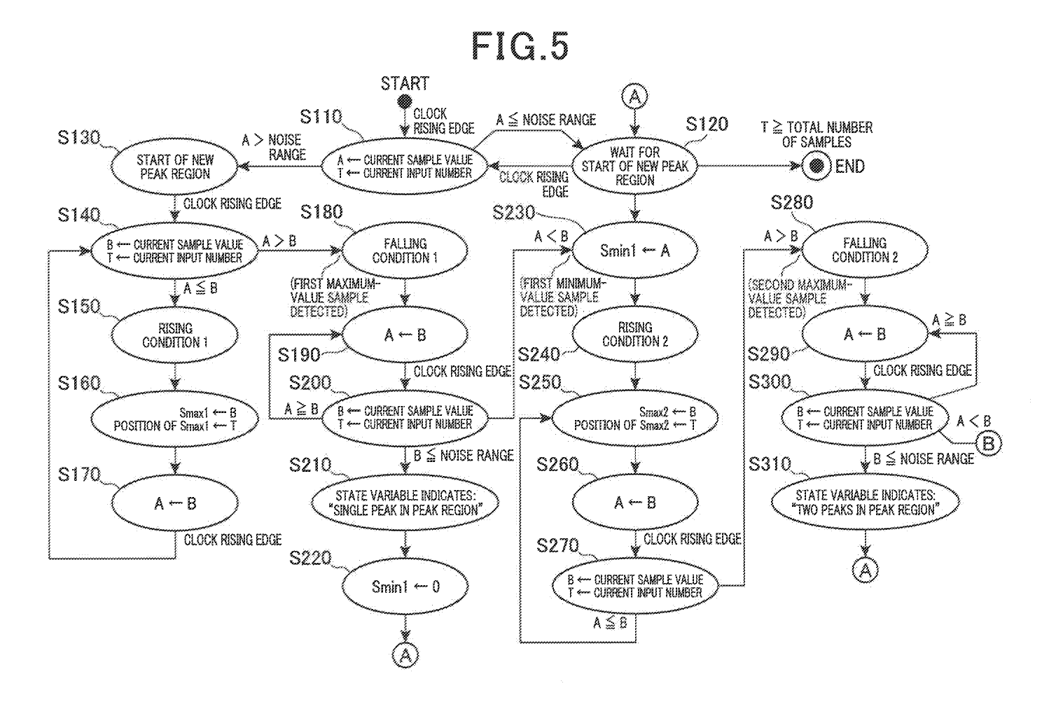

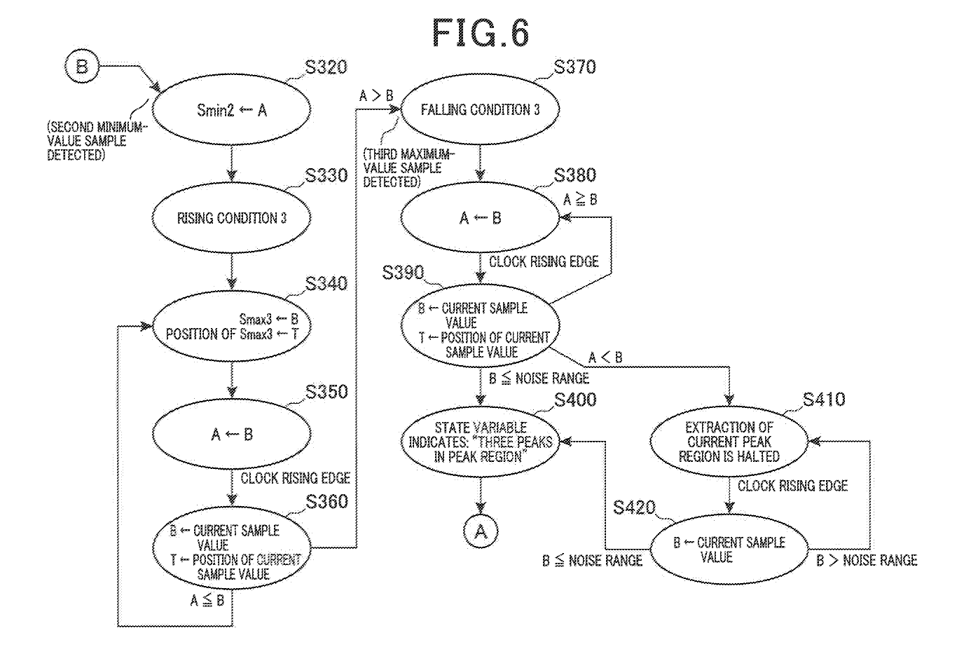

The data analysis processing for extracting successive peak regions and for detecting maximum-value and minimum-value samples within each peak region (processing of step S10 of FIG. 3) during an operation interval (Tw) will be described in the form of a state transition diagram. This expresses successive transitions of a state machine, shown in FIGS. 5 and 6, with the function of a state machine being performed by processing executed by each distance measurement circuit 32.

As successive samples of the received signal Ri are obtained by A/D conversion during an operation interval, the data (ai, ti) of the samples are stored in respective memory locations, (for subsequent use in the processing of step S20 of FIG. 3). Of these, a set of memory locations are reserved for each extracted peak region, for storing the data of up to three maximum-value samples (designated as Smax1, Smax2, Smax3) and up to two minimum-value samples (designated as Smin1 and Smin2) which may be detected in that peak region, and for storing a value (peak separation number) which indicates the number of maximum-value samples detected in the peak region, (value attained by a state variable) as described in the following.

In addition, three data registers (memory locations) designated as the A, B and T registers are used by the distance measurement circuit 32, to temporarily store respective values (designated in the following as the A, B and T values) during extraction of each peak region.

In each (Tw) operation interval, functioning of the state machine commences when a series of samples begin to be produced by A/D conversion of the received signal Ri, and write-in of data into memory (into registers) becomes enabled. Successive samples are acquired by the state machine at respective rising edges of a clock signal (i.e., synchronized with A/D conversion timings). Each time a transition to a new state occurs (i.e., a change in status), the recorded value of a state variable (i.e., with respective values having predetermined significances) is updated, to express the new status. The respective states of the state machine are designated in the form “Sxxx”, as shown in FIGS. 5, 6.

After operation of the state machine commences, a transition to the state S110 occurs at the next rising edge of the clock signal, i.e., at a timing when the amplitude ai and time-axis position (input number) ti of a first sample of the input signal Ri are inputted to the state machine, and are respectively registered as the values A and T.

If the value A is judged to be within the noise range a transition is made to state S120, in which the state variable is set to indicate “peak region waiting”.

The value T is then compared with a fixed number, (the total number of samples produced in each operation interval Tw). If T≧the fixed number, operation of the state machine is terminated.

At the next rising edge of the clock signal, state S110 is re-entered, and the values A and T are updated to the amplitude and input number values of the next sample. If the value A exceeds the noise range, a transition is made to state S130. Otherwise, the state sequence S110→S120→S110 is successively repeated (i.e., a “peak region waiting” condition is continued) until the value A exceeds the noise range.

When the state S130 is entered (i.e., commencement of extracting a new peak region from the series of samples), the state variable is set to indicate “start of a new peak region”. At the next rising edge of the clock signal, state S140 is entered, in which the amplitude and input number of the next sample are registered as the values B and T. The values A and B are then compared, to judge whether successive sample values are increasing or decreasing. The amplitude relationship between these values A and B is recorded as a status value (i.e., which indicates either that A≦B or A>B). At that time, the value A is that of the preceding sample, i.e., of one clock period previously, while B is the value of the currently acquired sample.

If it is judged in S140 that there is a rising condition of the current peak region (i.e., A≦B), state S150 is then entered, in which the state variable is set to indicate “rising condition 1”. State S160 is then entered, in which the value B is registered as Smax1 (i.e., is provisionally stored in the memory location assigned for the first maximum-value sample of this peak region), while the value T is similarly registered as the position (input number) of Smax1.

Next in state S170, the value A is replaced by B (i.e., contents of register A made identical to contents of register B). At the next rising edge of the clock signal, state S140 is re-entered. Thereafter, so long as the amplitude values of successive samples are above the noise range and it is judged that A≦B in state S140, the sequence S140→S150→S160→S170 is successively repeated as a loop. Each time the loop is executed, the values registered as Smax1 and “position of Smax1” are updated in S160 (to the values B and T, respectively), so that Smax1 successively increases.

If it is judged in state S140 that there is a failing condition (i.e., A>B, indicating that successive sample values are decreasing), state S180 is then entered, in which the state variable is set as “falling condition 1”. Since it is detected that the state variable value has changed from indicating “rising condition 1” to indicating “falling condition 1”, a first maximum-value sample has been detected in the current peak region. Hence, the values currently registered for Smax1 and “position of Smax1”, of this peak region, are left stored (for subsequent use in step S20 of FIG. 3), as the amplitude and time-axis position respectively of the first maximum-value sample of this peak region.

It can be understood from the above that, after updating the values B and T in S140, i.e., after selecting the next sample of the series as the object sample, a status value (value of the state variable) is recorded in accordance with the relationship between the amplitude values A and B at that time. That is, the status value indicates either that A<B (i.e., a rising condition, in which sample values are successively increasing) or that A≧B (i.e., a falling condition, in which sample values are successively decreasing, or remain unchanged). When the status value indicates a change from the rising condition to the falling condition, it is judged that a maximum-value sample has been detected (as the sample immediately preceding the object sample). Conversely, when a change occurs from the falling condition to the rising condition, this indicates that the sample preceding the object sample is a minimum-value sample.

Following S180, state S190 is then entered, in which the value A is replaced by the value B. At the next rising edge of the clock signal, state S200 is entered in which the values B and T are respectively replaced by the amplitude and input number of the next sample. The values A and B are then compared, and if A≧B while also B is above the noise range, S190 is returned to, and the value A is replaced by the value B. Thereafter, so long as the values of successive samples are above the noise range and A≧B (i.e., the falling condition continues), the state sequence S200→S190→S200 is successively repeated as a loop.

However if it is found in state S200 that the value B is within the noise range, this indicates that the end of the current peak region has been reached and that this peak region is not divided (i.e., contains only a single peak). Hence state S210 is entered, in which the state variable is registered as indicating “single peak” for this peak region, and that state variable value is thereafter left stored (for subsequent use in step S20). Next in state S220, “Smin1” is registered as 0 (indicating that this peak region does not contain a minimum-value sample). Operation then returns to S120, described above, to wait for the start of a new peak region.

However if it is found in state S200 (i.e., after updating the values B and T) that A<B, while B is above the noise range, it is judged that a transition has occurred from a first falling condition to a second rising condition. Hence in state S230 the value A is stored as Smin1 (i.e., as the amplitude of the first minimum-value sample of this peak region) then in S240 the state variable is registered as indicating “rising condition 2”.

In state S250 following S240, the values B and T are respectively registered as Smax2 and “position of Smax2”, then in state S260 the value A is replaced by value B. At the next rising edge of the clock signal, state S270 is entered, in which the amplitude and input number of the next sample are registered as the values B and T respectively.

The values A and B are then compared, If A≦B, it is judged that the second rising condition of the peak region is continuing, and S250 is then returned to. So long as this second rising condition. continues, the state sequence S250→S260→S270→S250 is successively repeated as a loop. Each time the loop is executed the values registered as Smax2 and “position of Smax2” are updated, so that Smax2 successively increases.

However if it is judged in state S270 (after updating the values B and T by data of the next sample) that A>B, this indicates that the second rising condition has ended (i.e., a second falling condition has commenced) and state S280 is then entered, in which the state variable is registered as indicating “falling condition 2”. This transition of the state variable indicates that a second maximum-value sample has been detected, so that the values currently registered for Smax2 and “position of Smax2” are left stored, as the amplitude and time-axis position of the second maximum-value sample of this peak region.

Following S280 in state S290, the value A is replaced by the value B. At the next rising edge of the clock signal, in state S300, the values B and T are respectively updated to the amplitude and input number of the next sample.

The values A and B are then compared, and if A≧B while also B is above the noise range, S290 is returned to, and the value A is replaced by B. Thereafter, so long as the amplitudes of successive samples are above the noise range and A≧B (i.e., so long as the second falling condition continues) the state sequence S300→S290→S300 is successively repeated as a loop.

However if it is found in state S300 (after updating B and T to the data of the next sample) that the value B is within the noise range, this indicates that extraction of the current peak region has been completed, and that this peak region contains two maximum-value samples (hence, contains two peaks). Thus in state S310 the state variable is registered as indicating “2 peaks”, and that state variable value is left stored as the peak separation number for this peak region (to be referred to thereafter in step S20). State S120 is then returned to, to wait for the start of the next peak region.

However if it is found in state S300 (after updating B and T) that A<B while also B exceeds the noise range, then it is judged that the current peak region has not yet been extracted completely, while there has been a transition to a third rising condition. In that case, operation proceeds to S320 (FIG. 6) in which the current value A is left stored as “Smin2” (amplitude of the second minimum-value sample of this peak region).

State S330 is then entered in which the state variable is set to indicate “rising condition 3”, then in state S340 the values B and T are registered as Smax3 and “position of Smax3” respectively.

S350 is then entered, in which the value A is replaced by the value B, then at the next rising edge of the clock signal, state S360 is entered, in which the values B and. T are updated to the data of the next sample. The values A and B are then compared, and if A≦B, it is judged that the third rising condition is continuing, and S340 is returned to. So long as this third rising condition continues, the state sequence S340→S350→S360→S340 is successively repeated as a loop.

Each time the loop is executed, the values registered as Smax3 and “position of Smax3” are updated, so that Smax3 successively increases. However if it is found in state S360 after updating B and T that A>B, it is judged that a third maximum value sample has been detected, and operation then proceeds to state S370 in which the state variable value is registered as indicating “falling condition 3”.

The currently registered values B and T are thereafter left stored as Smax3 and “position of Smax3” respectively (i.e., as the amplitude and input number of the third maximum-value sample of this peak region).

S380 is then entered in which value A is replaced by value B. At the next rising edge of the clock signal, in state S390, the data of the next sample are registered as the values B and T respectively.

The values A and B are then compared, and if A≧B while B exceeds the noise range, it is judged that the third falling condition of the peak region is continuing, and operation returns to state S380. So long as the third falling condition continues and the value B exceeds the noise range, the state sequence S380→S390→S380 is successively repeated as a loop.

However if it is found, after updating B and T with data of the next sample in S390, that the value B is within the noise range, it is judged that extraction of the current peak region has been completed, with this peak region containing three maximum-value samples. In that case, S400 is entered, in which the state variable is registered as indicating “3 peaks”, and the state variable value is thereafter left stored as the peak separation number for this peak region. S120 is then returned to, to wait for the start of the next peak region.

If it is found in state S390 that A<B while also B exceeds the noise range, this is judged to indicate that there is a fourth rising condition, and S410 is then entered. It would be possible at this point to proceed to detecting and registering a fourth maximum-value sample, however with this embodiment no more than three maximum-value samples can be detected in a peak region. Hence in S410, the status “peak detection halted” is set (no action is taken). At the next rising edge of the clock signal, in S420, the value B is updated to the amplitude of the next inputted sample. If B is judged to exceed the noise range, then since this indicates that extraction of the current peak region has not yet been completed, operation returns to S410. So long as extraction of the current peak region continues, the state sequence S410→S420→S410 is successively repeated as a loop, without performing peak detection.

If it is found in S420 that the value B is within the noise range, it is judged that extraction of the current peak region has been completed, and operation proceeds to S400, described above, then returns to S120 to wait for the start of the next peak region.

If it were required to detect up to four maximum-value samples in a peak region (for detecting up to four peak values), this could be achieved by executing the same state sequence as S320→S390 between S410 and S420, and thereafter performing the same processing for detecting the fourth part of the peak region as that described above for detecting the third part. Similarly the embodiment could be modified to be capable of detecting more than four peaks in a peak region.

As can be understood from the above, with this embodiment, maximum-value samples and minimum-value samples within a peak region are detected based on detecting transitions between rising portions and falling portions of the peak region. This is done by selecting a currently inputted sample as an object sample (registered as the value B, in one of the states S140, S200, S270, S300 or S360 of FIGS. 5, 6) and comparing the object sample value with that of the immediately preceding sample (registered as the value A), to thereby detect whether successive samples are successively increasing or successively decreasing in value.

Upon completion of the processing of FIGS. 5, 6 for extracting a peak regions, five sets of output values remain, stored in memory, corresponding to that peak region, i.e.:

(1) Smax1, “position of Smax1” (amplitude and time-axis position of first maximum-value sample)

(2) Smax2, “position of Smax2” (amplitude and time-axis position of second maximum-value sample, if detected)

(3) Smax3, “position of Smax3” (amplitude and time-axis position of third maximum-value sample, if detected)

(4) Smin1 (amplitude of first minimum-value sample, if detected)

(5) Smin2 (amplitude of second minimum-value sample, if detected)

In addition, the corresponding peak separation number is stored for each peak region, expressing the number of maximum-value samples that have been detected for the peak region

If the embodiment were modified to enable detection of peak regions containing 4 or more peaks, then the number of these sets of output values would be accordingly increased.

Processing performed in step S20 (FIG. 3) following S10, for calculating peak threshold values of each peak region and using the peak threshold values to calculate positions of peaks in the received signal Ri, is executed as follows. Firstly, for each of the extracted peak regions, peak threshold values (reference values respectively corresponding to each maximum-value sample of the peak region) are calculated in accordance with appropriate, one of the following sets of equations (1) to (3):

Equation (1) (valid when peak region contains only single maximum-value sample):

Peak threshold value 1=Smax1×k (0<k<1)

Equations (2) (valid when peak region contains 2 maximum-value samples):

Peak threshold value 1={(Smax1−Smin1)×k}+Smin1 (0<k<1)

Peak threshold value 2={(Smax2−Smin1)×k}+Smin1 (0<k<1)

Equations (3) (valid when peak region contains 3 maximum-value samples, and Smin1 Smin2):

Peak threshold value 1={(Smax1−Smin1)×k}+Smin1 (0<k<1)

Peak threshold value 2={(Smax2−Smin1)×k}+Smin1 (0<k<1)

Peak threshold value 3={(Smax3−Smin2)×k}+Smin2 (0<k<1)

Equations (4) (valid when peak region contains 3 maximum-value samples, and Smin1<Smin2):

Peak threshold value 1={(Smax1-−Smin1)×k}+Smin1 (0<k<1)

Peak threshold value 2={(Smax2−Smin2)×k}+Smin2 (0<k<1)

Peak threshold value 3={(Smax3−Smin2)×k}+Smin2 (0<k<1)

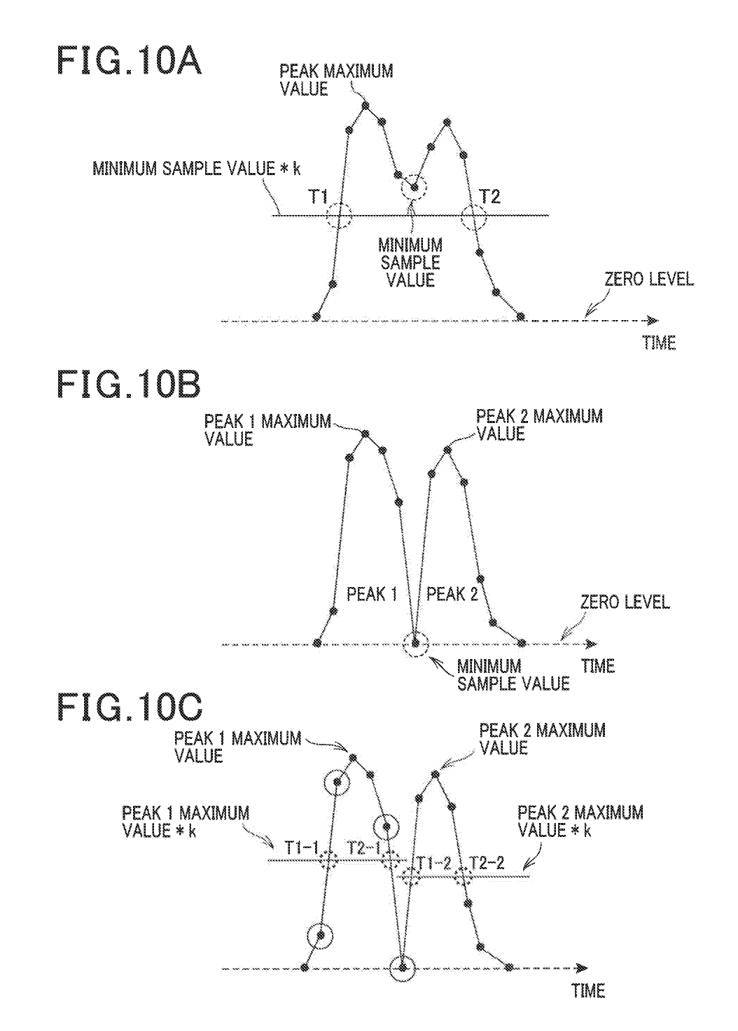

This method of setting peak threshold values basically differs from that of reference document 1 as follows. With the method of reference document 1, a fixed base value (zero signal level) is used as a reference value for detecting the time-axis position of a peak value of the sampled signal. This makes it necessary to forcibly reduce the value of each minimum sample to the zero level (as illustrated by FIGS. 10A and 10B). This change from the actual amplitude of each minimum sample, prior to executing peak position estimation, causes inaccuracy as described above.

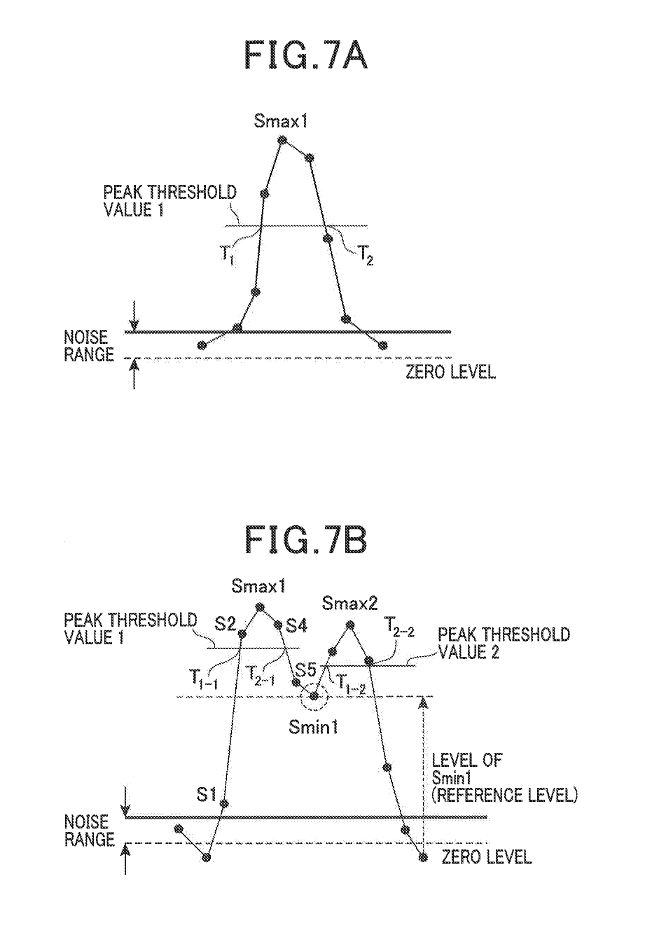

However with the present invention, the amplitude of each minimum-value sample is left unchanged. In the example of FIG. 7B, the minimum value Smin1 is used, unchanged, as a basis for calculating the peak threshold values 1 and 2. Thus, intersection timings such as T₂₋₁ and T₁₋₂ in FIG. 7B for example can be accurately obtained, since there is no distortion of the amplitude values of the sampled signal.

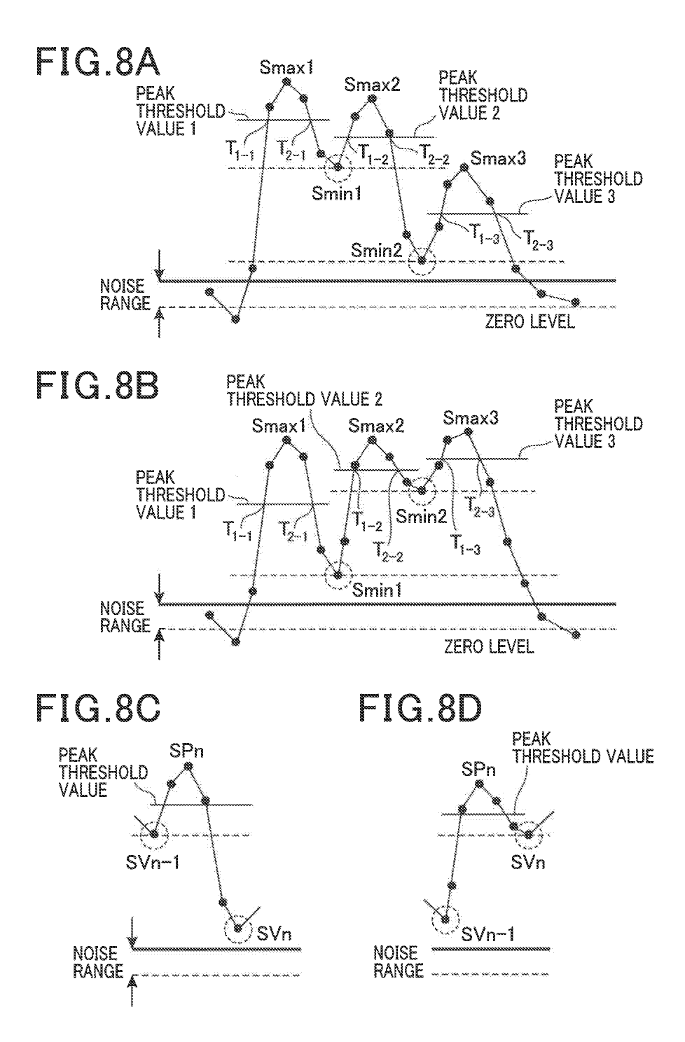

With the present embodiment, the number of peaks which can be detected in a peak region is limited to 3, however the invention is equally applicable to detecting an arbitrary number of peaks of a sampled signal. This can be done by applying the following rule when a peak region contains three or more maximum-value samples (hence, contains three or more peak values). Referring to FIGS. 8C, 8D, if SPn is the final maximum value in the peak region, or an adjoining preceding minimum value SVn-1 is higher than the adjoining succeeding minimum value SVn (e.g., FIG. 8C), then the peak threshold value corresponding to SPn is calculated based on the preceding minimum value SVn-1.

Conversely, if SPn is the first maximum value in the peak region, or the adjoining preceding minimum value SVn-1 is lower than the adjoining succeeding minimum value SVn (e.g., FIG. 8D), the peak threshold value corresponding to SPn is calculated based on the succeeding minimum-value sample SVn-1.

Upon completion of calculating peak threshold values for each of the extracted peak regions, the following output values have been determined for each peak region:

(1) Peak separation number (indicating “single peak” or “2 peaks”, or “3 peaks”),

(2) Peak threshold value 1, or peak threshold values 2, 3, or peak threshold values 1, 2, 3

(3) Positions of maximum-value samples Smax1, Smax2, Smax3

For each peak region, the peak threshold value(s) obtained from the valid set of equations (1) to (3) above is/are selected, in accordance with the peak separation number determined for that peak region.

For example as described above referring to FIGS. 5 and 6, if the state variable value has becomes successively changed in the sequence indicating:

“single peak”→“wait for start of new peak region” at completion of extracting a peak region, a corresponding peak separation number indicating “single peak” is left stored in memory with respect to that peak region, in the processing of step S10. In that case, the result (peak threshold value 1) obtained by applying equation (1) is selected, as the valid peak threshold value for that peak region.

Similarly, if the peak separation number indicates “2 peaks”, the results from equations (2) above are selected as the valid peak threshold values 1 and 2 for that peak region. If the peak separation number indicates “3 peaks”, the results from either equations (3) or equations (4) above are selected as being valid sets of peak threshold values 1, 2 and 3 with equations (3) or equations (4) being selected based on the amplitude relationship between the minimum sample values Smin1 and Smin2 registered for that peak region.

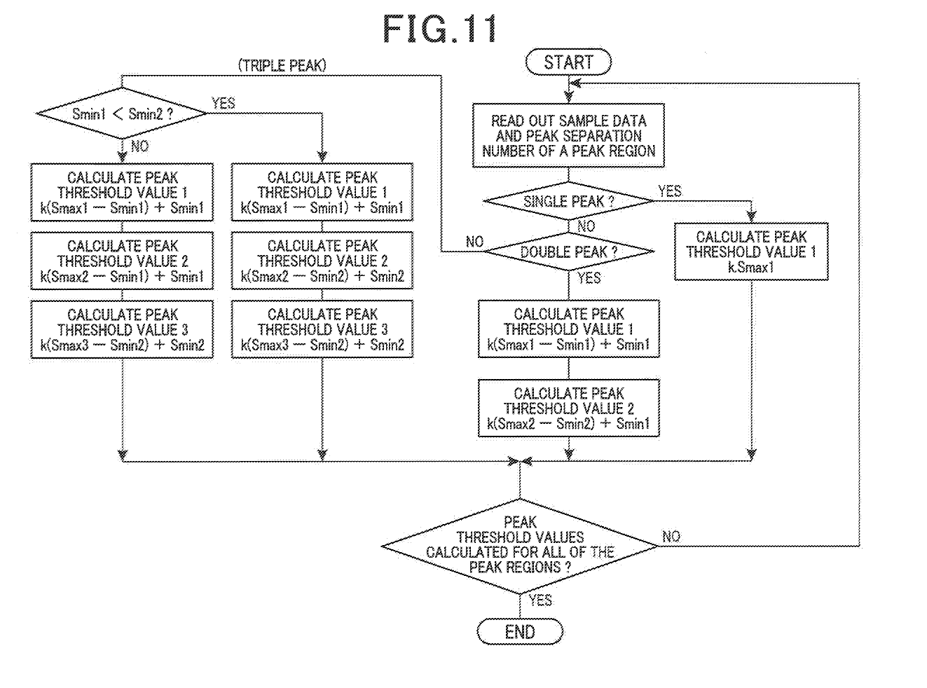

The above processing executed in step S20 of FIG. 3 for calculating the peak threshold values for respective peak regions is illustrated by the flow diagram of FIG. 11.

Each peak region is then processed to estimate the time-axis positions of peaks (i.e., amplitude peaks of the received signal Ri) within that peak region. Essentially, for each maximum-value sample, the position of a corresponding peak is estimated based on a corresponding group of samples. The group corresponding to a maximum-value sample consists of successively adjacent samples which include the maximum-value sample and which are each higher in value than the peak threshold value corresponding to that maximum-value sample. More specifically, the peak position is estimated as being within the range of time-axis positions of that corresponding group of samples.

Referring for example to the maximum-value sample Smax1 in FIG. 7B, a group of three samples (S2, Smax1, S4) have higher values than the peak threshold value corresponding to Smax1. Hence the position of a received signal peak is estimated based on the time-axis positions of that group of three samples.

With this embodiment, for each peak region containing a plurality of peaks, the distance measurement circuit 32 calculates a pair of intersection timings T1-n, T2-n (n=1 or 2) corresponding to each of the maximum-value samples of the peak region, based on the peak threshold value corresponding to that maximum-value sample. The first intersection timing is derived based on comparing the peak threshold value with samples which precede the maximum-value sample and which include samples of the group corresponding to that maximum-value sample. The second intersection timing is derived based on comparing the reference value with samples which succeed the maximum-value sample and which include samples of the corresponding group.

For example in the case of the intersection timings T1-1, T2-1 obtained with respect to the first maximum value (Smax1) of the peak region shown in FIG. 7B, T1-1 is calculated based on the timings of samples S1, S2 and the amplitude relationship between the peak threshold value 1 and the samples S1, S2 (assuming a linear variation of amplitude with time between S1 and S2). The intersection timing T2-1 is similarly calculated based on the samples S4, S5 and the peak threshold value 1.

The position of a first peak of the received signal is calculated as the mid-point of these intersection timings T1-1 and T2-1. The timings (time-axis positions relative to time of transmitting of a laser light beam pulse) of successive peak values in the received signal (i.e., peak values of received light intensity) are thereby estimated.

Next (step S30 of FIG. 3) the estimated time-axis positions of the peaks in the received signal are converted by the distance measurement circuit 32 to corresponding distance values. Since the derivation of distance values (target range values) from timings of received reflected radar waves is well known, detailed description is omitted. These distance values are supplied from each of the four channels of the distance measurement circuit 32 to the signal processing section 40, for use in deriving information including distance, direction, etc., of detected target objects.

With the above embodiment, at completion of extracting a peak region in step S10, a value of the state variable is stored (as a peak separation number) to serve as information indicating whether the peak region contains one, two or three peaks. However as an alternative to this, it could be arranged for example that the information is obtained (in the processing of step S20) based upon whether values have been recorded for none, one, or two minimum-value samples (as Smin1, Smin2) for the peak region concerned.

### Effects Obtained by Embodiment

With the above embodiment, peak regions (groups of successive samples above a predetermined base value) are successively extracted from a sampled signal which expresses intensity values of received reflected light waves (radar waves). When an extracted peak region contains a plurality of peaks of the sampled signal, a plurality of peak threshold values are established for use in estimating the time-axis positions of the peaks relative to a reference time point. With the embodiment, each peak threshold value is set based on an actual (local) minimum value of the samples within the peak region. Since each minimum value is left unchanged, the time-axis positions of the peaks can be accurately estimated. Hence, the embodiment enables the distances to target objects to be accurately calculated.

Furthermore with a distance measurement circuit 32 of the above embodiment, when processing the samples of a peak region to detect maximum-value samples and minimum-value samples, the samples are operated on as successive pairs. The values of the currently specified sample (the object sample) and that of the immediately preceding sample are compared, and the status of the magnitude relationship is recorded. When the object sample is found to be higher in value than the preceding sample, the status is recorded as a “rising condition”, while if the object sample is lower than the preceding value, the status is recorded as a “falling condition”. When there is a change from the rising condition to the falling condition, the preceding sample value (at that point) is detected as being a maximum value. Similarly when there is a status change from the falling condition to the rising condition the preceding sample value is detected as being a minimum value.

Hence, maximum and minimum values (i.e., local maximum and local minimum values) in the sequence of sample values can be detected in a simple manner, by operating only on successive pairs of sample values. This enables more efficient processing and hence a reduction of the processing load (simpler logic operations), by comparison with prior art methods in which successive sets of three or more sample values of a series are evaluated for detecting the minimum and maximum values.

### Alternative Embodiments

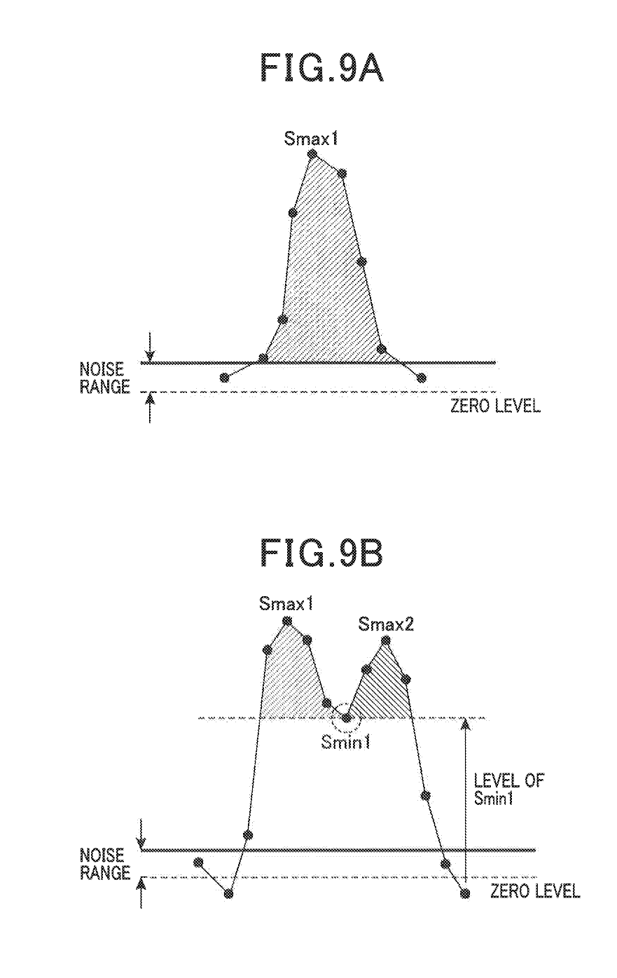

The invention is not limited in scope to the above embodiment, and various modifications or alternative forms of the above embodiment may be envisaged. For example as illustrated in FIGS. 9A 9B it would be possible for the distance measurement circuit 32 to be configured for plotting the samples of each peak region as respective points (ai, ti) in a 2-dimensional graph, to obtain (with respect to each maximum-value sample) the area that is enclosed between the corresponding group of samples of that maximum-value sample (as defined hereinabove) and the corresponding peak threshold value. Specifically, the corresponding group of samples are expressed as a continuous succession by interpolating amplitude values between adjacent samples, on the assumption of linear variation of amplitude with time. This condition is illustrated by the straight-line segments which connect each adjacent pair of samples in the examples of FIGS. 9A, 9B.

In the example of FIG. 9A, in which the peak region has a single maximum value, the peak threshold value is the base level (zero level). The position of a peak value within that peak region obtained as the time-axis position of the centroid of the contained region (shown as a hatched-line area).

In the example of FIG. 9B, the peak region has two maximum values (Smax1, Smax2) and the peak threshold value is set as the minimum sample value (level of Smin1). Thus two contained regions are obtained. In that case, the estimated positions of signal peaks corresponding to Smax1 and Smax2 are obtained as the time-axis positions of the respective centroids of the contained regions.

It would be equally possible to employ other methods of estimating time-axis positions of peaks in a peak region which contains a plurality of maximum-value samples, other than those described above. The essential points are that, for each maximum-value sample, a corresponding reference value (corresponding peak threshold value) is derived based on an adjoining minimum-value sample, a corresponding group of samples (as defined hereinabove) is thereby determined, and the time-axis position of a peak value of the sampled signal is obtained as a position within the range of time-axis positions of that corresponding group.

### Relationship between Claims and Embodiment

The following relationships exists between the above embodiment and items recited in the appended claims. A distance measurement circuit 32 corresponds to “sampling circuitry” and “distance measurement circuitry”. A distance measurement circuit 32, in executing the processing of steps S10, S20 of FIG. 3, corresponds to “data analysis circuitry”. Furthermore in, executing the processing of step S10, a distance measurement circuit 32 corresponds to “maximum/minimum value detection circuitry”, and in executing the processing of step S20. corresponds to “peak position estimation circuitry”, The light emission section 10 corresponds to a “transmitting apparatus”, while the light receiving section 20 corresponds to a “receiving apparatus”.

In the appended claims and the description, the term “position” of a sample signifies a position within a series of samples which have been generated at a fixed. sampling frequency commencing at a specific time point, so that a position (input number) within the series defines a specific time-axis position of a sample. The terms “maximum-value sample” and “minimum-value sample” refer to samples having a local maximum value and a local minimum value respectively, within a series of samples. The term “value” as applied to a signal sample signifies the amplitude value of the sample. The term “pair of adjacent samples” signifies two samples which are adjacent to one another within a series of samples. The term “adjoining minimum-value sample”, used in relation to a maximum-value sample, signifies a minimum-value sample which immediately precedes or immediately succeeds that maximum-value sample in a sequence of alternating maximum-value samples and minimum-value samples.

What is claimed is:

1. A data analysis apparatus for processing a series of samples of an input signal to detect time-axis positions of peak values of said input signal, the samples obtained by sampling said input signal at a fixed sampling frequency, the apparatus including
maximum/minimum value detection circuitry configured to operate on said series of samples as a series of amplitude values having respective time-axis positions, for detecting maximum-value samples and minimum-value samples within said series, and
peak position estimation circuitry for estimating said time-axis positions of peak values, based upon said detected maximum-value samples and minimum-value samples;
wherein said peak position estimation circuitry is configured to:
determine, for each of said maximum-value samples, a corresponding reference value and a corresponding group of samples, said corresponding reference value being set higher than a value of a minimum-value sample which adjoins said maximum-value sample, said corresponding group comprising a plurality of successively adjacent samples which include said maximum-value sample and have respective values above said reference value, and
estimate a time-axis position of a peak value of said input signal as a position within a range of time-axis positions of said corresponding group.

2. The data analysis apparatus according to claim 1, wherein said maximum/minimum value detection circuitry comprises
comparator circuitry controllable for judging a value relationship between one of said samples, currently specified as an object sample, and a sample immediately preceding said object sample in said series,
status recording circuitry configured to record a status value indicative of said value relationship,
time-series control circuitry configured to select successive ones of said series of samples as said object sample, and
extreme value detection circuitry configured to be responsive to a change of said status value for detecting said immediately preceding sample as being a maximum-value sample or a minimum-value sample.

3. The data analysis apparatus according to claim 2, wherein
said status value is predetermined as indicating a rising condition, when said object sample is judged to be higher in value than said immediately preceding sample, and is predetermined as indicating a falling condition when said object sample is judged to be lower in value than said immediately preceding sample, and
said extreme value detection circuitry is configured to detect said immediately preceding sample as being a maximum-value sample when said status value changes from indicating said rising condition to indicating said falling condition, and to detect said immediately preceding sample as being a minimum-value sample when said status value changes from indicating said falling condition to indicating said rising condition.

4. The data analysis apparatus according to claim 1 wherein said peak position estimation circuitry is configured to
derive a first intersection timing and a second intersection timing as respective time-axis positions, with respect to each of said maximum-value samples for which a corresponding reference value is obtained,
said first intersection timing being derived based on comparing said corresponding reference value with samples which. precede said maximum-value sample and which include at least one sample of said group corresponding to said maximum-value sample, said second intersection timing being derived based on comparing said corresponding reference value with samples which succeed the maximum-value sample and which include at least one sample of said group corresponding to said maximum-value sample;
and is configured to derive an estimated time-axis position of a peak value of said sampled signal as a position midway between said first and second intersection timings.

5. The data analysis apparatus according to claim 1 wherein said peak position estimation circuitry is configured to:
express each of said groups corresponding to said maximum-value samples in the form of a two-dimensional region enclosed between said sample values of said group and said corresponding threshold value, said samples plotted as points in a graph of amplitude values with respect to time values, and each pair of adjacent sample values of the group connected by line segments constituted by interpolated amplitude values; and
obtain said estimated time-axis position of a peak value of said input signal as a position of a centroid of said enclosed region.

6. The data analysis apparatus according to claim 1 wherein said peak position estimation circuitry is configured whereby, when a maximum-value sample is preceded by a first adjoining minimum-value sample and is succeeded by a second adjoining minimum-value sample, said corresponding reference value of said maximum-value sample is made higher than a higher one of said first minimum-value sample and said second minimum-value sample.

7. The data analysis apparatus according to claim 1, wherein said maximum/minimum value detection circuitry is configured to:
extract from said series of samples a plurality of peak regions, each of said peak regions comprising a plurality of successively adjacent samples having respective values exceeding a predetermined base value, and
operate on each of said peak regions in succession, for detecting maximum-value samples and minimum-value samples within each of respective peak regions containing a plurality of maximum-value samples;
and wherein said peak position estimation circuitry is configured to determine, for each maximum-value sample of a peak region containing a plurality of maximum-value samples, said corresponding reference value as being above a value of a higher one of a pair of minimum-value samples which adjoin said maximum-value sample and which respectively precede and succeed said maximum-value sample.

8. A radar apparatus including a transmitting apparatus for transmitting radar waves, a receiving apparatus for receiving said radar waves after reflection from target objects and deriving a received signal varying in amplitude in accordance with intensity of said received. radar waves, an analog/digital converter circuit for converting said received signal to a series of samples, and distance measurement circuitry configured for estimating respective distances of said target objects based on said series of samples,
wherein:
said distance measurement circuitry comprises a data analysis apparatus as claimed in claim 1, configured for operating on said series of samples of said received, signal to derive estimated time-axis positions of peak values of said received signal; and
said distance measurement circuitry is configured to calculate said distances of target objects based upon said estimated time-axis positions of said peak values.

9. A radar apparatus including a transmitting apparatus for transmitting radar waves, a receiving apparatus for receiving said radar waves after reflection from target objects and deriving a received signal varying in amplitude in accordance with intensity of said received radar waves, an analog/digital converter circuit for converting said received signal to a series of samples by sampling at a fixed frequency, and distance measurement circuitry for operating on said series of samples to estimate respective distances of said target objects;
wherein:
said distance measurement circuitry comprises maximum/minimum value detection circuitry, peak position estimation circuitry and distance estimation circuitry,
said maximum/minimum value detection circuitry is configured to operate on said series of samples as a series of amplitude values having respective time-axis positions, for extracting from said series of samples a plurality of peak regions, each of said peak regions comprising a plurality of successively adjacent samples having respective values exceeding a predetermined base value, and for detecting maximum-value samples and minimum-value samples within each of respective peak regions containing a plurality of maximum-value samples,
said peak position estimation circuitry is configured to determine, with respect to each of said plurality of maximum-value samples of a peak region, a corresponding reference value and a corresponding group of samples, said corresponding reference value being higher than a minimum-value sample which adjoins said maximum-value sample, said corresponding group comprising a plurality of successively adjacent samples including said maximum-value sample and having respective values exceeding said corresponding reference value, and to estimate, with respect to each of said plurality of maximum-value samples, a time-axis position of a peak value of said input signal as a position within a range of time-axis positions of said group corresponding to said maximum-value sample, and
said distance measurement circuitry is configured to calculate said distances of target objects based upon said estimated time-axis positions of said peak values.

10. A data analysis apparatus for processing a series of samples of an input signal, obtained by sampling said input signal at a fixed sampling frequency, the apparatus including
maximum/minimum value detection circuitry configured to operate on said samples as a series of amplitude values having respective time-axis positions, for detecting each of a plurality of maximum-value samples and a plurality of minimum-value samples within said series, and
peak position estimation circuitry for estimating time-axis positions of peak values of said input, signal based upon said detected maximum-value samples and minimum-value samples;
wherein said peak position estimation circuitry is configured to:
determine, for each of said detected maximum-value samples, a corresponding reference value and a corresponding group of samples, said reference value being higher than a higher one of respective values of a pair of minimum-value samples which adjoin said maximum-value sample and respectively precede and succeed said maximum-value sample, said corresponding group comprising a plurality of successively adjacent samples including said maximum-value sample and having respective values exceeding said reference value, and
estimate a position of a peak value of said input signal as a time-axis position that is within a range of time-axis positions of said corresponding group.

11. The data analysis apparatus according to claim 10, wherein said maximum/minimum value detection circuitry comprises:
comparator circuitry configured for comparing respective values of a first one of said samples, currently selected as an object sample, and of a sample immediately preceding said object sample in said series,
status recording circuitry configured to record a status value as indicating a rising condition when said object sample is judged to be higher in value than said immediately preceding sample, and to record said status value as indicating a falling condition when said object sample is judged to be lower in value than said immediately preceding sample,
time-series control circuitry configured to control said comparator circuitry for designating successive ones of said series of samples as said object sample, and extreme value detection circuitry configured to detect said immediately preceding sample as being a maximum-value sample, when said status value changes from indicating said rising condition to indicating said falling condition, and to detect said immediately preceding sample as being a minimum-value sample when said status value changes from indicating said falling condition to indicating said rising condition.

12. A method of data analysis for estimating respective time-axis positions of peak values of an input signal by processing a series of samples of said input signal, said series obtained by sampling said input signal at a fixed sampling frequency, the method comprising steps of:
analyzing said series of samples, to detect respective maximum-value samples and minimum-value samples within said series, and
estimating said time-axis positions of said peak values of said input signal, based upon said detected maximum-value samples and minimum-value samples;
wherein said step of estimating time-axis positions of said peak values comprises:
deriving, for each of said maximum-value samples, a corresponding reference value and a corresponding group of samples, said reference value being set higher than a value of a minimum-value sample which adjoins said maximum-value sample, said corresponding group comprising a plurality of successively adjacent samples including said maximum-value sample and having respective values above said reference value, and
estimating a time-axis position of a peak value of said input signal based on time-axis positions of said samples of said corresponding group.

13. The method of data analysis according to claim 12, wherein said calculation of said reference value corresponding to said maximum-value sample comprises:
calculating a difference between respective values of said maximum-value sample and said adjoining minimum-value sample, and multiplying said difference by a predetermined factor, said factor having a value between zero and one, and
adding a result of said multiplication to said value of the minimum-value sample, to obtain said corresponding reference value.

14. The method of data analysis according to claim 12, wherein said step of analyzing said series of samples to detect positions of maximum-value samples and minimum-value samples comprises
designating each of said series of samples, in turn, as an object sample,
comparing respective values of said object sample and of a sample which immediately precedes said object sample in said series,
when said object sample is judged to be higher in value than said immediately preceding sample, recording a status values as indicating a falling condition, and when said object sample is judged to be lower in value than said immediately preceding sample, recording said sample value as indicating a rising condition;
when said status value changes from indicating said rising condition to indicating said falling condition, detecting said immediately preceding sample as being a maximum-value sample, and
when said status value changes from indicating said falling condition to indicating said rising condition, detecting said immediately preceding sample as being a minimum-value sample.

15. A method of data analysis executed by circuitry configured to operate as a state machine, for analyzing a series of samples of an input signal to detect maximum-value samples and minimum-value samples within said series, said state machine executing a series of data processing operations in accordance with successively entered states, the method comprising:
selecting each of said series of samples, in turn, as an object sample, and comparing respective values of a currently selected object sample and of a sample which immediately precedes said object sample;
when said object sample is judged to be higher in value than said immediately preceding sample, recording a status value as indicating a rising condition, and when said object sample is judged to be lower in value than said immediately preceding sample, recording said sample value as indicating a falling condition;
when said status value changes from indicating said rising condition to indicating said falling condition, detecting said immediately preceding sample as being a maximum-value sample, and
when said status value changes from indicating said falling condition to indicating said rising condition, detecting said immediately preceding sample as being a minimum-value sample.
